(19) United States
(12) Patent Application Publication
(10) Pub. No.: US 2017/0359646 A1
(43) Pub. Date: Dec. 14, 2017

(54) Cable Set

(71) Applicant: Klang:technologies GmbH, Aachen (DE)

(72) Inventors: Roman Scharrer, Aachen (DE); Pascal Dietrich, Aachen (DE); Benedikt Krechel, Aachen (DE)

(21) Appl. No.: 15/630,683

(22) Filed: Jun. 22, 2017

Related U.S. Application Data
(63) Continuation of application No. PCT/EP2015/080942, filed on Dec. 22, 2015.

(30) Foreign Application Priority Data
Dec. 22, 2014 (DE) 102014018928.7

(51) Int. Cl. H04R 1/10; H04R 29/00; H04R 1/32; G01D 5/02; G01D 5/12

(52) U.S. Cl. CPC H04R 1/1091; H04R 1/1008; G01D 5/02; H04R 1/1033; G01D 5/12; H04R 1/32; H04R 29/00

(57) ABSTRACT

A cable set including at least one electrical audio conductor for transmitting an audio signal from a receiver unit to a head phone or ear phone, wherein the at least one electrical audio conductor includes a first end provided with a first plug and connectable with the head phone or ear phone and a second end that is arranged opposite to the first end, wherein at least one sensor configured to measure an orientation of the sensor is arranged at a distance of 40 cm at the most from the first end of the at least one electrical audio conductor and attached at the at least one electrical audio conductor. The invention also relates to a method for transmitting an audio signal from a monitoring unit to headphones or earphones arranged at a head of a bearer.

### RELATED APPLICATIONS

This application is a continuation of International Application PCT/EP2015/080942 filed on Dec. 22, 2015 claiming priority from German Patent Application DE 10 2014 018 928.7 filed on Dec. 22, 2014, both of which are incorporated in their entirety by this reference.

### FIELD OF THE INVENTION

The invention relates to a cable set including at least one electrical audio conductor for transmitting an audio signal from a receiving unit to head phones or ear phones, wherein the at least one audio conductor includes a first end provided with a first plug and connectable with the head phones and ear phones and a second end that is arranged opposite to the first end.

The invention furthermore relates to a method for transmitting an audio signal from a monitoring unit to head phones or ear phones arranged at a head of a bearer, the method including the steps:

a) transmitting the audio signal from the monitoring unit to a receiving unit arranged at a body of a bearer,

b) transmitting the audio signal from the receiving unit through a cable set which includes at least one electrical audio conductor which includes a first end that is provided with a first plug and connect able with head phones or ear phones and a second end that is arranged opposite to the first end to the head phones or ear phones.

It is provided according to the invention that the ear phones are inserted into the ear cup or an outer ear canal. Ear phones are often also designated as “ear buds” and “in ear phones”. The instant application however also relates to head phones in particular bar head phones enveloping the ear.

### BACKGROUND OF THE INVENTION

Cable sets of the general type described supra are known in the art and are typically used for custom ear phones for musicians, for example concert or stage musicians.

The main reason is that musicians at least after the introduction of electro acoustically amplified concerts cannot perceive exactly anymore whether they play or sing too loud, not loud enough or at the right tempo compared to other participating musicians. On the one hand side there is an amplified acoustic signal for the audience and on the other hand side there are the amplified acoustic signals of the other band members. Therefore it can happen that a singer does not hear his own singing due to a drum set or the drummer does not hear the singing of the singer.

In order to solve this problem so called “monitoring” was introduced which does not only facilitate controlling the audio signal to the audience also generates an individual audio signal for each musician with the corresponding volume ratios. At the beginning only so called monitoring of speakers at a base of the floor was used. Only with an introduction of a wireless audio connection also in ear headsets configured as acoustic converters became possible. When performing in ear monitoring the audio signal is typically received by a receiver unit which the musician carries with him and forwarded by the cable set to the custom made ear phone. Typically the second end is connected with a receiver unit for the audio signal in a permanent or disengage able manner.

The cable set is typically made from one or two audio conductors which are respectively connected or connectable at a first end with a head set or ear phone and at a second end with the receiver unit. Using two head phones or ear phones which typically have a high level of sound insulation has the advantage that the musician can perceive the audio signal transmitted to him without the audio signal being influenced by external sounds. However, when using head phones or ear phones a noise level, e.g. of the audience is reduced so that the musicians have difficulties perceiving and detecting the ambient mood. Therefore this effect is undesirable for some musicians.

In particular since purchasing ear phones due to their individual adaptation to an ear anatomy of a bearer is very expensive it is desirable for many musicians that only the cable set has to be replaced when the cable set is defective. Therefore a respective audio cable of the cable set typically has a plug at its first end for connecting with the head phone or ear phone and a plug for connecting with the receiver unit at its second end.

It is a disadvantage of the recited head phones or ear phones with cable sets attached thereto that the audio signal causes an unnatural space perception and thus a very uncomfortable audio perception for the musician since the sound perception does not change with in ear monitoring when the musician moves or turns. In a worst case scenario this causes orientation problems for the musician.

Furthermore WO 2013/144371 A1 describes a head set with a bar, wherein an inertia sensor and a GPS sensor are arranged in the bar. This type of head phone is particularly suited for navigation or audio city tours which are played using a smart phone. The sensors provide a position and an orientation of the bearer. Therefore an audio signal of the navigation system or of the audio city tour can be played back as a function of the position and orientation (viewing direction) of the bearer.

In AU 2012 100 113 A2 at least an ear phone with a sensor is described. The sensor can be a touch sensor or a position sensor. Using the at least one sensor an electrical audio device shall be controlled by gesture recognition. For example when the ear phone is taken out of the ear this is registered by the position sensor. Therefore the audio device is switched off. Moving the head towards the left shoulder can cause forwarding, moving the head towards the right shoulder can cause rewinding. Alternatively also two sensors which are respectively arranged in one of the ear phones can detect a position change of the respective ear phone which causes a change at the electronic audio device. The at least one ear phone is permanently connected with a cable. This type of device is particularly suitable for cases where for example music is being listened to and an undesirable song shall be forwarded but no hands are available to operate a keyboard.

US 2008/0019554 A1 illustrates an ear phone where different filters can be inserted as required. In order to replace the filter it is required that also the cable can be separated from the ear phone. However, the ear phone does not provide a sensor to determine for example a position and/or a face orientation of a musician.

The object illustrated in US 2011/0316611 A1 is a cable that is disengageably connected with an ear phone and an electronic device wherein a control sensor is arranged in the cable. The control sensor controls the electronic device. The cable includes a plug for connecting with the ear phone at a first end and a plug for connecting with the electronic device at a second end of the cable. The control sensor is an actuation element (keying element) through which a person carrying the object can for example spool tracks back and forth.

US 2014/0006026 describes head mounted display glasses (HMD glasses) which facilitate transmitting images to a bearer in real time. At places where the optical lenses are typically inserted there are small displays. Additionally motion sensors are attached at the glasses which adapt the image to a movement of the bearer.

### BRIEF SUMMARY OF THE INVENTION

Thus it is an object of the invention to improve upon the cable set recited supra so that the musician can be provided with an audio signal when bearing the head phone or ear phone wherein the audio signal corresponds to the natural and spatial hearing properties. It is another object of the invention to improve the method recited supra so that the musician is provided with an audio signal when wearing the head phone or ear phone wherein the audio signal corresponds to the natural spatial hearing properties.

The object is achieved by a cable set including at least one electrical audio conductor for transmitting an audio signal from a receiver unit to a head phone or an ear phone, wherein the at least one electrical audio conductor includes a first end that is provided with a first plug that is connectable with the head phone or ear the phone and a second end that is arranged opposite to the first end, wherein at least one sensor that is configured to measure an orientation of the at least one sensor that is attached at the at least one electrical audio conductor at a distance of 40 cm at the most from the first end of the at least one electrical audio conductor.

The object is also achieved by a method for transmitting an audio signal from a monitoring unit to a head phone or an ear phone arranged at a head of a bearer, the method including the steps transmitting the audio signal from the monitoring unit to a receiver unit arranged at a body of the bearer; conducting the audio signal from the receiver unit through a cable set that includes at least one electrical audio conductor that includes a first end that is provided with a first plug that is connectable with an ear phone or head phone wherein the cable set includes a second end that is arranged opposite to the first end and wherein the audio signal is conducted to the head phone or ear phone, wherein at least one sensor measures an orientation of the at least one sensor relative to ambient, wherein the at least one sensor is arranged at a distance of 40 cm at the most from the first end of the at least one electrical audio conductor and attached to the first end of the at least one electrical audio conductor, wherein the orientation of the at least one sensor is forwarded through a signal conductor to a transmitter unit arranged at the body of the bearer and subsequently transmitted to the monitoring unit, and wherein the monitoring unit puts out the audio signal as a function of the orientation of the at least one sensor.

Improving upon the device described supra the object is achieved by at least one sensor for measuring an orientation of the sensor wherein the sensor has a distance of 40 cm at the most from the first end of the first audio conductor and is attached at the audio conductor.

The sensor is configured to measure an orientation and positioning of a musician bearing the cable set (bearer) so that a location of the bearer on a stage and consequently an approximately exact positioning of the musicians relative to each other can be determined and/or on the other hand side a position of the head relative to its neutral position looking straight forward can be determined. The head can move from its neutral position about three axes. Using the sensor thus for example also the position of the head after a head movement about its transversal axis (pitch movement), longitudinal axis (yaw movement) and/or sagittal axis (roll movement) can be measured. The sensor should thus be attached at the cable set and the cable set should be borne by the bearer so that relative movements between the sensor and the cable set as well as cable set and bearer are excluded so that the sensor actually reflects a position and orientation of the head of the bearer.

Determining the orientation and positioning of the sensor or the bearer bearing the cable set is provided by high resolution tracking, thus it is provided that the at least one sensor can detect a change of an orientation of the sensor or the bearer of advantageously under 15°, further advantageously under 10°, further advantageously under 5°, further advantageously under 1°. Further advantageously the at least one sensor can detect a positioning of the sensor or the bearer of advantageously better than 4 m, further advantageously better than 2 m, further advantageously better than 1 m, further advantageously better than 20 cm.

Based on the measured orientation an accordingly configured audio signal can be forwarded to the bearer. The audio signal arriving at the bearer is not independent from position any more but the audio signal naturally follows the head movement, this means the play back of the audio signal is naturally adapted to the head movement. Thus, the bearer has a true spatial perception of the music in his environment in spite of the custom made head phone or ear phone which is normally almost impervious to ambient sounds. Independently from how and where the bearer moves on a stage or in a room while all advantages of in-ear monitoring have been maintained.

The position of the head can be determined in particular due to the maximum distance of 40 cm between the sensor and the first end so that the sensor detects at least a yaw movement, advantageously also a pitch and roll movement of the head. An increasing distance between the sensor and the first end leads to ever more imprecise measurement values since a correlation between the sensor position and the head movement becomes significantly less.

Attaching the sensor at the at least one first audio signal conductor is performed for example by gluing, encasement and/or a plug-in connection so that the sensor cannot disengage from the audio conductor or slide along the audio conductor.

It is an advantage of the cable set that the first end of the audio conductor includes a plug which is typically connectable with commercially available custom head phones or ear phones so that potential buyers of the cable set do not need to purchase a new custom head phone or ear phone but only have to replace the existing cable set with the cable set according to the invention. Thus, the cable set according to the instant application does not include an ear phone of head phone but is connectable therewith. The ear phone or head phone includes a speaker which in turn is an electro acoustic converter. This means that initially mechanical oscillations are generated from an electrical audio signal by a converter and sound waves are generated therefrom.

Plugs according to the instant application shall be male as well as female plug elements as well as combinations of both.

A particularly precise orientation can be measured by the sensor in that it is provided according to the invention that a distance between the sensor and the first end of the at least one electrical audio conductor is at the most 30 cm, advantageous at the most 20 cm, further advantageously at the most 20 cm, further advantageously at the most 10 cm. The safety of obtaining good correlation between sensor and head movement is thus further increased.

Further configuring the invention it is provided that the second end of the audio conductor is connected with a receiver unit or a transmitter unit. Thus, the cable set includes the at least one audio conductor, the sensor and a receiver unit and/or transmitter unit. The control signal measured by the sensor shall thus be transmitted to the transmission unit, wherein the transmission unit forwards the control signal to a central monitoring unit. Based on the incoming control signal an accordingly configured audio signal is computed and forwarded through the receiver unit and the at least one audio conductor attached thereon to the head phones or the ear phones.

Alternatively a second plug is arranged at the second end of the at least one audio conductor wherein the second plug is disengageably connectable to an external receiver unit or an external transmitter unit. This has the advantage that upon a defect of the cable set the receiver unit or transmitter unit which were part of the cable set according to the preceding alternative do not have to be replaced as well. This provides cost savings. Additionally different receiver units and transmitter units are being used depending on the monitoring unit. In this case the cable set can be connected due to the second plug with the receiver unit or transmitter unit adapted to the monitoring unit and is not tied to a permanently connected transmitter unit or receiver unit.

A variation of the invention provides that the first plug on the ear phone side differs from the second plug. The first plug which shall be normally connected with the standard custom made ear phones or head phones has another configuration than the second plug that is connectable with the receiver unit or transmitter unit. The first plug as well as the second plug are selected so that the cable set according to the invention is connectable with typical custom made ear phones, receiver units and transmitter units respectively with standardized plug connectors. It is advantageously provided that the first plug establishes an electrical plug connection to the ear phone or head phone.

In an advantageous embodiment of invention it is provided that the sensor is connectable or connected by at least one electrical signal conductor with the transmitter unit and/or the receiver unit, wherein at least one control signal is directly or indirectly transmittable to the transmitter unit through the electrical signal conductor. A direct transmission of the control signal occurs when the signal conductor is connected or connectable directly with the transmitter unit, whereas an indirect transmission occurs in cases in which for example a receiver unit is arranged between the signal conductor and the transmitter unit and the control signal is run through the transmitter unit or its housing.

The electrical signal conductor includes a first end which is connected with the sensor and which is arranged on a side of the signal conductor that is oriented towards the head phone or the ear phone. Accordingly the first end of the signal conductor is arranged remote from the first end of the at least one audio conductor, advantageously by 40 cm at the most, further advantageously by 30 cm at the most, further advantageously by 20 cm at the most, further advantageously by 10 cm at the most. A second end of the signal conductor that is arranged opposite to the first end, thus an end of the signal conductor that is oriented away from the head phone or ear phone can be directly connected with the transmitter unit or the receiver unit. In this case the transmitter unit or the receiver unit is part of the cable set.

Alternatively it is provided according to the invention that the electrical signal conductor includes a plug at an end oriented away from the head phone or ear phone, wherein the plug can be disengageably connected with a separate transmitter or receiver unit. A separate transmitter or receiver unit is advantageous in particular for different monitoring units so that the cable set can be flexibly connected with any transmitter unit or receiver unit.

Particularly simple handling is provided when the second end of the signal conductor is run into the same plug as the second end of the audio conductor. This means that the audio conductor as well as the signal conductor terminate in the second plug. Consequently the audio signal as well as the control signal are run through the transmitter unit or the receiver unit. Consequently when the second plug is connected with the receiver unit the control signal would initially be conducted by the signal conductor to the receiver unit and only thereafter to the transmitter unit, wherein the forwarding of the audio signal can be performed directly from the receiver unit to the head phone or the ear phone. However, when the plug is connected with the transmitter unit direct forwarding of the control signal to the transmitter unit is performed and thus to the monitoring unit, however in this case the audio signal first has to be conducted from the receiver unit to the transmitter unit first before it is run to the head phone or the ear phone.

In particular in case that the at least one audio conductor and the signal conductor are arranged with the respective second end in the second plug it is provided in a particularly advantageous embodiment of the invention that the transmitter unit and the receiver unit are connected with each other through a connecting conductor so that a transmission of the control signal or the audio signal to the corresponding unit is possible. It has proven advantageous that the connecting conductor is another audio conductor or signal conductor and is advantageously connected at both ends respectively with a plug.

The cable sets known in the art are only connected with the receiver unit since no transmitter unit is required. Since no transmitter unit is required the typical receiver units only include a connection for forwarding the audio signal to the head phones or ear phones. Consequently it is particularly advantageous when the second plug which has to forward an audio signal as well as a control signal is initially connected with the transmitter unit. In the transmitter unit the control signal can be processed and forwarded to the central monitoring unit. The audio signal can then be conducted from an existing receiver unit through the connecting conductor and the transmitter unit to the audio cable. The head phones or the ear phones and the receiver unit from existing systems can thus be used and accordingly only the new cable set with the transmitter unit has to be installed between the receiver unit and the head phone or ear phone. Certainly the cable set can also include the transmitter unit so that the audio conductor and the signal conductor are permanently connected with the transmitter unit.

Another embodiment according to the invention provides a second electrical audio conductor for transmitting an audio signal, wherein the second electrical audio conductor is provided at a first end with a third plug which is connectable with a second head phone or an ear phone and connected at a second end either with the second plug or connectable with a fourth plug with the receiver unit or the transmitter unit or connected at the second end with the receiver unit or the transmitter unit or connectable or connected with a fifth plug at the first head phone or ear phone. When using two head phones or ear phones a particularly true perception of the interaction of the different musicians can be provided to the bearer using the bi-aural technique in an audio signal without distortions and interference noises occurring from an outside.

The measurement of the orientation of the at least one sensor can be transferred to the orientation of the head when the at least one sensor is arranged at the first and/or third plug of the at least one electrical audio conductor. The reason is among other things that the ear phone is typically inserted into the ear of the bearer in a non-movable manner. The at least one sensor which is now arranged directly at the head phone or ear phone and thus proximal to the ear due to the arrangement in the first and/or third plug can only change its orientation through a head movement. Consequently the orientation of the sensor corresponds to the position of the head advantageously relative to the neutral position of the head.

Advantageously the at least one electrical audio conductor and/or the at least one second audio conductor and/or the at least one signal conductor are arranged in sections directly adjacent to each other, advantageously twisted with each other and/or enveloped by a common outer shell wherein advantageously the electrical audio conductors and the advantageously at least one electrical signal conductor divide at a branch off into two strands in a direction of the first ear phone and the second ear phone so that a distance between the first plug and/or the third plug and the branch off is 40 cm at the most, further advantageously 30 cm at the most. In particular when the signal conductor and the first and the second audio conductor are connected at their respective second end with the second plug an arrangement directly adjacent to each other is advantageous since this avoids that the conductors are knotted into each other or a conductor is accidently pulled for example from the second plug.

The conductors separate again at the branch off so that for example the first audio conductor together with the signal conductor which can continue to be twisted together are run to the first head phone or ear phone and the second audio conductor is run to the second head phone or ear phone. The distance of the branch off from the respective first end should thus be advantageously 40 cm at the most so that the distance over which the conductors do not knot together in particular when the cable set is not used is as small as possible. However, the distance should be selected large enough so that the bearer is not restricted and agreeable bearing comfort is provided.

A measured orientation of the sensor so that the orientation is transferable to the orientation of the head is still provided when it is provided according to the invention that the at least one sensor is arranged in the branch off.

An advantageous embodiment, however, provides that at least one additional sensor is arranged in the branch off. The at least one additional sensor can measure for example reference values which can be compared with the measurement values of the at least one sensor. Thus, in addition to the head orientation also the relative orientation between head and body can be determined which impacts the processing of the bi-aural audio signals.

Alternatively it is feasible that the at least one sensor as well as the at least one additional sensor is arranged in the branch off, wherein this can be useful in particular when the sensors measure different physical variables.

Advantageously it is provided that the at least one sensor is a rate of turn sensor and/or a motion sensor and/or a magnetometer, in particular an inertial sensor and/or a yaw sensor. These sensors facilitate a particularly good measurement of the sensor so that it can consequently be determined with sufficient precision in which position the head is currently disposed and at which position the bearer stands on the stage.

It is provided in a variation of the invention that the at least one additional sensor is a rate of turn sensor and/or a motion sensor and/or a magnetometer, in particular an inertial sensor and/or a yaw sensor and/or a temperature sensor and/or an air pressure sensor and/or a humidity sensor and/or a microphone. Measuring different parameters provides a chance for a more precise representation of the orientation of the sensor.

In case the sensor is a microphone which is for example formed by a sound pressure sensor a current ambient noise can be mixed into the bi-aural audio signal. This is particularly useful in order to facilitate perceiving a mood of the audience and for providing communications with the other musicians during performance breaks, in particular without taking the ear phones out.

In order to keep a distance between the respective first end and the respective second end of the respective audio conductor and/or signal conductor as short as possible it can be advantageous when the receiver unit and/or the transmitter unit is attached at the branch off. The risk that a musician gets caught somewhere with the at least one audio conductor or signal conductor is thus reduced.

Last not least is provided according to the invention that the receiver unit and the transmitter unit are arranged in a pocket transmitter. Accordingly the musician only has to attach the pocket transmitter, for example at his pants or belt which facilitates a space saving arrangement of the transmitter and receiver unit.

Last not least the method according to the invention can be further improved as follows:

c) at least one sensor measures its orientation relative to an ambient, wherein the sensor is arranged at a distance of 40 cm at the most from the first end of the at least one electrical audio conductor and is attached at the electrical audio conductor.

d) the orientation of the sensor is forwarded through a signal conductor to a transmitter unit that is arranged at the body of the bearer and subsequently transmitted to the monitoring unit, and

e) the monitoring unit puts out the audio signal as a function of the orientation of the at least one sensor.

The purpose of measuring the orientation of the sensor and the advantages correspond to the purpose and the advantages described supra for the cable set.

Typically the monitoring unit is arranged at a distance from the bearer of the cable set which is typically between 1 m and 100 m, advantageously typically between 2 m and 50 m.

Advantageously the monitoring unit includes a processing unit, an audio unit and at least one transmitting and receiving unit. The at least one transmitting and receiving unit can receive signals regarding an orientation of the sensor relative to its ambient from the transmitter unit which is arranged at a bearer. Using the processing unit the orientation signals can be processed. Subsequently the audio unit can forward the audio signal corresponding to the orientation of the bearer to the transmitter unit and the receiver unit wherein the transmitter and receiver unit can transmit the audio signal to the receiver unit which is arranged at the corresponding bearer.

It is provided that the signal conductor can also be part of the cable set, wherein the signal conductor can advantageously conduct a signal from the sensor to the transmitter unit at the bearer, wherein the signal reflects the orientation of the sensor.

### BRIEF DESCRIPTION OF THE DRAWINGS

The invention described supra is subsequently described in more detail based on embodiments with reference to drawing figures, wherein:

FIG. 1 illustrates a schematic representation of a cable set according to the invention in a first embodiment;

FIG. 2 illustrates a schematic representation of the cable set according to the invention in a second embodiment;

FIG. 3 illustrates a schematic representation of a bearer of the cable set according to the invention in a third embodiment;

FIG. 4 illustrates a schematic representation of a bearer of the cable set according to the invention in a fourth embodiment, and

FIG. 5 illustrates two carriers of a cable set according to FIG. 3.

### DETAILED DESCRIPTION OF THE INVENTION

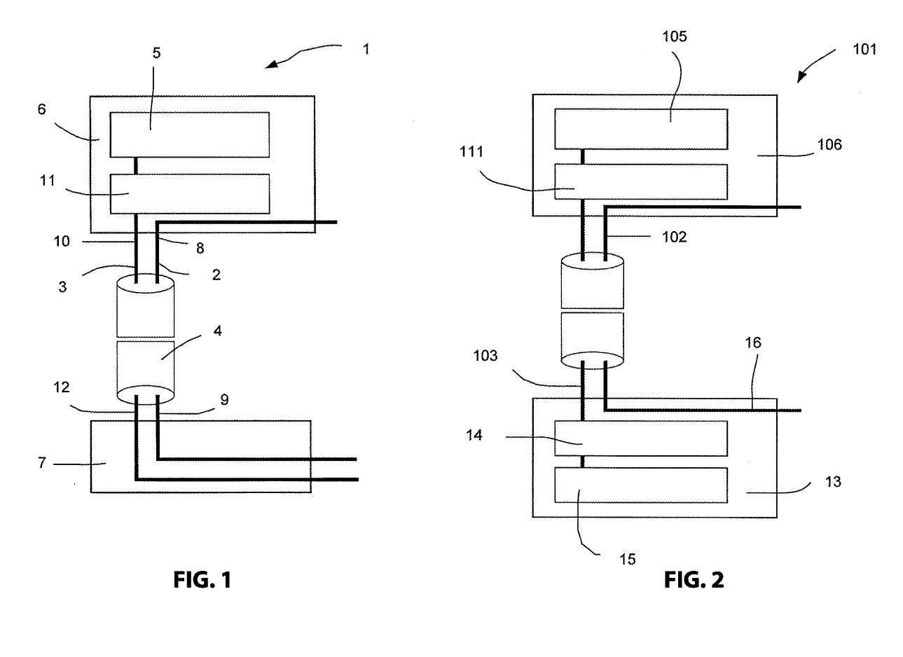

FIG. 1 illustrates a cable set 1 according to the invention with an audio conductor 2 and a signal conductor 3 which are jointly enveloped in sections by an outer shell 4. Furthermore the cable set 1 includes a sensor 5, a first plug 6 and a second plug 6, 7.

The first plug 6 is arranged at a first end 8 of the audio conductor 2. This plug 6 is connectable with a non-illustrated head phone or ear phone so that an audio signal is transmittable to a musician bearing the head phone or ear phone (=bearer). A second end 9 of the audio conductor 2 that is arranged opposite to the first end 8 includes the second plug 7.

The signal conductor 3 that extends parallel to the audio conductor 2 is connected at its first end 10 with a pre-processing unit 11 and the sensor 5, wherein the pre-processing unit 11 and the sensor 5 are arranged in the first plug 6. Consequently a distance between the sensor 5 and the first end 10 of the audio conductor is almost zero. An orientation of the sensor 5 that changes through the movement of the bearer in space is measured by the sensor 5 and converted into a control signal. The control signal is now forwarded by the signal conductor 3 in a direction towards a second end 12 of the signal conductor 3 which second end is arranged opposite to the first end 10, wherein the second end 12 of the signal conductor 3 as well as the second end 9 of the audio conductor 2 is connected with the second plug 7.

The second plug 7 can be connected in a disengageable manner with a transmitter or receiver unit which is not illustrated so that the control signal can be conducted by the transmitter unit to a central monitoring unit or an audio signal is received by the receiver unit and forwarded through the audio conductor 2 to the head phone or ear phone.

FIG. 2 schematically illustrates a second embodiment of a cable set 101 according to the invention, wherein the cable set 101 differs from the cable set 1 according to FIG. 1 in that the cable set 101 includes a transmitter unit 13 that is permanently connected with the cable set 101 instead of a second plug 7, wherein a data processing module 14 and a radio module 15 are arranged in the transmitter unit 13. Consequently the cable set 101 includes an audio conductor 102, a signal conductor 103, a first plug 106, a sensor 105 and the transmitter unit 13.

The control signal is transmitted by the sensor 105 and a pre-processing unit 111 to the transmitter unit 13. The transmitter unit 13 forwards the control signal by the radio module 15 to a central non-illustrated monitoring unit.

The transmitter unit 13 can be connected through a connecting conduit 16 with a non-illustrated receiver unit. The audio signal which is typically received by a receiver unit and subsequently directly forwarded to the head phone or ear phone has to be transmitted initially through the connection unit 16 which is advantageously also an audio conductor to the transmitter unit 13 and subsequently through the audio conductor and the first plug 106 to the head phone or ear phone.

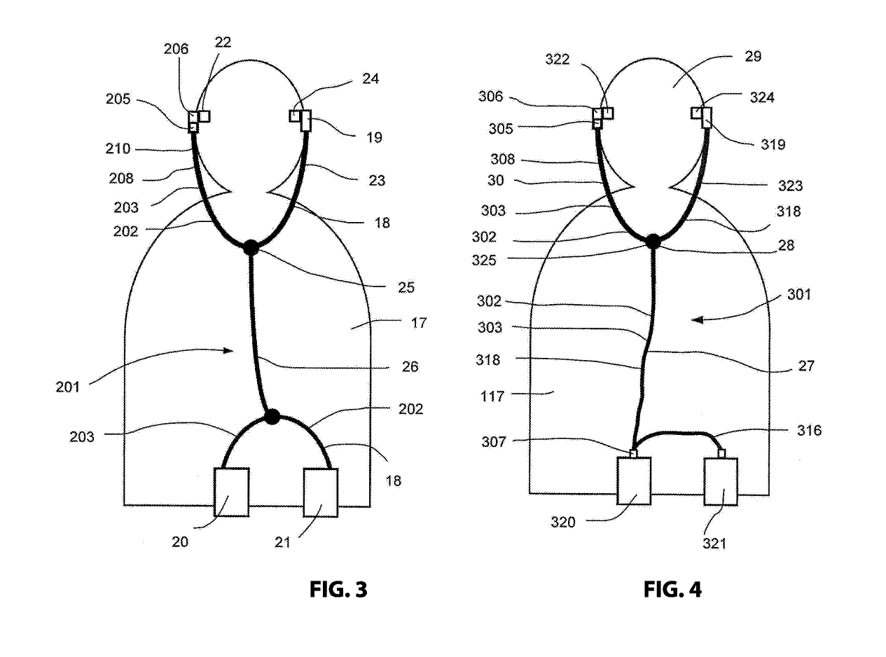

FIG. 3 illustrates how a bearer 17 would bear another embodiment of a cable set 2 or 1 according to the invention. The cable set 201 is made from a first audio conductor 2 and a second audio conductor 18, a signal conductor 203, a sensor 205, a first plug 206, a third plug 19 and a transmitter unit 20 which corresponds to the transmitter unit 13 according to FIG. 2 and a receiver unit 21.

A first end 208 of the first audio conductor 202 is connected by the first plug 206 to a first ear phone 202 and a first end 203 of the second audio conductor 18 is connected through the third plug 19 with a second ear phone 24. In the first plug 206 there is furthermore the sensor 205 for measuring an orientation of the sensor 205. The sensor 205 is connected with the signal conductor 203, wherein the first audio conductor 202 and the signal conductor 203 are joined at their respective first ends 208, 210. At a first branch off 25 the first audio conductor 208 and the signal conductor 203 are joined with the second audio conductor 18 and twisted with each other. A section 26 along which the three conductors 18, 202, 203 are joined is approximately 1 m.

Subsequently the signal conductor 203 is run away from the first audio conductor 202 and the second audio conductor 18 and is permanently connected with the transmitter unit 20. The two audio conductors 18, 202 are permanently connected with the receiver unit 21.

FIG. 4 illustrates an additional bearer 117 of a cable set 301 according to the invention in another embodiment. The cable set 301 includes a first audio conductor 302, a second audio conductor 318 a first signal conductor 303 and a second signal conductor 27, a first plug 306, a second plug 307 a third plug 319, and a first sensor 305 and a second sensor 28.

A first end 308 of the first audio conductor 302 is connected with the first plug 306 and the first end 323 of the second audio conductor 318 is connected with the third plug 319 wherein the first plug 306 and the third plug 319 are respectively disengageably connected with the ear phones 322, 324.

In the first plug 306 there is the first sensor 305 configured as an inertial sensor for measuring the position of the head 29. The head 29 illustrated in FIG. 4 is arranged in a neutral position. The sensor 305 is connected with the signal conductor 303 which is joined with the first audio conductor 302 in a first portion 30. At a branch off 325 in which the second sensor 28 is arranged in the form of a motion sensor the first audio conductor 302, the second audio conductor 318, the signal conductor 303 and the second signal conductor 27 joined and are enveloped by a non-illustrated outer shell. The four conductors 302, 303, 27 and 318 lead into the second plug 307 which is disengageably connected with an external transmitter unit 320.

Through the signal conductors 27, 303 a respective control signal is forwarded by the transmitter unit 320 to a central monitoring unit.

In order for an audio signal to be conducted by a receiver unit 321 through the transmitter unit 320, the second plug 307, the first audio conductor 302, and/or the second audio conductor 308 and the first plug 306 and/or the third plug 319 the transmitter unit 320 and the receiver unit 321 are connected with each other by a connecting conductor 316 configured as an audio conductor.

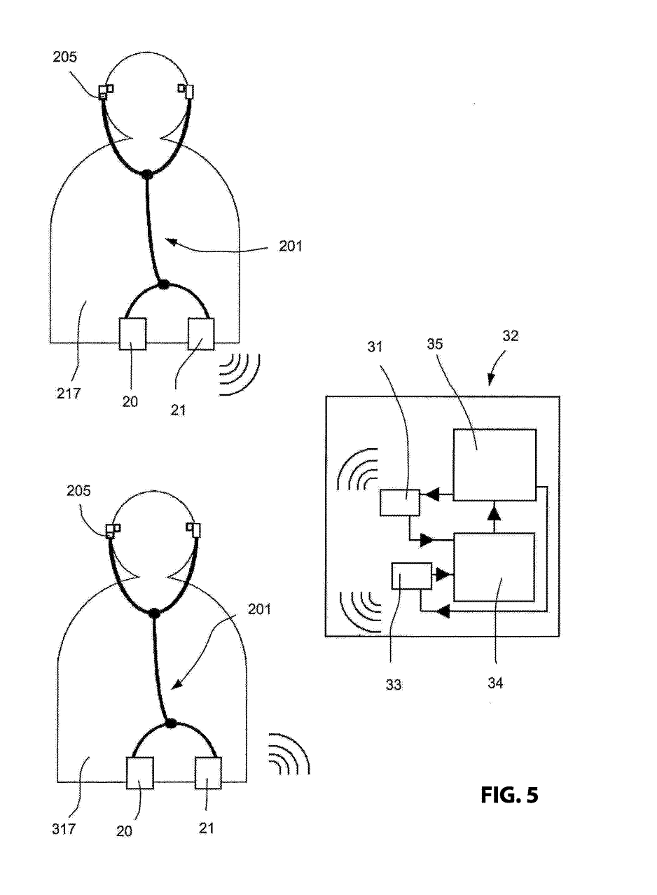

In FIG. 5, two carriers 217, 317 of a cable set 201 according to FIG. 3 are illustrated. Through the transmitter unit 20 of the first conductor 217 signals regarding the orientation of the sensor 215 are forwarded to a first transmitter and receiver unit 31 of a monitoring unit 32. Analogously thereto the transmitter unit 20 of the second bearer 317 sends signals regarding the orientation of the sensor 205 of the second bearer 317 to a second transmitter and receiver unit 33 of the monitoring unit 32. Additional bearers of the cable set according to the invention respectively provided with separate transmitter and receiver units are not illustrated but within the scope and spirit of the invention.

The incoming signals with respect to the orientation of the sensor 205 are forwarded respectively by the two transmitter and receiver units 31 and 33 of the monitoring unit 32 to a respective processing unit 34 of the monitoring unit 32 and processed therein. The generated control signal is respectively transmitted to an audio unit 35 and an output of the audio signal from the audio unit 35 that is dependent from the orientation of the respective sensor 205 relative to its ambient is provided to the first transmitter and receiver unit 31 and the second transmitter and receiver unit 33 which respectively transmit the respective audio signal to the respective receiver units 21 arranged at the bearer 217, 317.

Thus, it is provided according to the invention that both bearer 217, 317 receive different audio signals since both sensors 205 typically are oriented differently relative to ambient and/or the local coordinates of both bearers typically deviate from each other and/or the bearers wish different mixes, thus differently mixed audio signals where for example individual instruments like drums, guitar, keyboard or others are omitted or reduced in signal strength.

### REFERENCE NUMERALS AND DESIGNATIONS

1, 101, 201, 301 cable set
2, 102, 202, 302 audio conductor
3, 103, 203, 303 signal conductor
4 outer shell
5, 105, 205, 305 sensor
6, 106, 206, 306 plug
7, 307 plug
8, 208, 308 end
9 end
10, 210 end
11, 111 pre-processing unit
12 end
13 transmitter unit
14 data processing module
15 radio module
16, 316 connecting conductor
17, 117, 217, 317 bearer
18, 318 audio conductor
19, 319 plug
20, 320 transmitter unit
21, 321 receiver unit
22, 322 ear phone
23, 323 end
24, 324 ear phone
25, 325 branch off
26 section
27 signal conductor
28 sensor
29 head
30 portion
31 transmitter and receiver unit
32 monitoring unit
33 transmitter and receiver unit
34 processing unit
35 audio unit

What is claimed is:

1. A cable set, comprising:
at least one electrical audio conductor for transmitting an audio signal from a receiver unit to a head phone or an ear phone,
wherein the at least one electrical audio conductor includes a first end that is provided with a first plug that is connectable with the head phone or ear the phone and a second end that is arranged opposite to the first end,
wherein at least one sensor that is configured to measure an orientation of the at least one sensor that is attached at the at least one electrical audio conductor at a distance of 40 cm at the most from the first end of the at least one electrical audio conductor.

2. The cable set according to claim 1, wherein a distance between the at least one sensor and the first end of the at least one electrical audio conductor is 30 cm at the most.

3. The cable set according to claim 1,
wherein the second end is connected with the receiver unit or a transmitter unit, or
wherein the second end includes a second plug which is connectable with the receiver unit or the transmitter unit.

4. The cable set according to claim 3, wherein the first plug differs from the second plug.

5. The cable set according to claim 1,
wherein the at least one sensor is connectable or connected through at least one electrical signal conductor with a transmitter unit or the receiver unit, and
wherein at least one control signal is directly or indirectly transmittable to the transmitter unit through the at least one electrical signal conductor.

6. The cable set according to claim 5, wherein the at least one electrical signal conductor includes a second plug at an end that is oriented away from the head phone or the ear phone.

7. The cable set according to claim 5,
wherein the transmitter unit and the receiver unit are connected with one another through a connecting conductor, and
wherein the at least one control signal or the audio signal is transmittable through the connecting conductor.

8. The cable set according to claim 3,
further comprising at least one second electrical audio conductor for transmitting an audio signal,
wherein the second electrical audio conductor is provided at a first end with a third plug that is connectable with a second head phone or ear phone and connected at a second end with the second plug, or
wherein the second electrical audio conductor is connectable or connected by a fourth plug with the receiver unit or the transmitter unit, or
wherein the second electrical audio conductor is connected with the receiver unit or the transmitter unit or is connectable or connected with a fifth plug at the head phone or ear phone.

9. The cable set according to claim 8, wherein the at least one sensor is arranged at the first plug or at the third plug of the at least one electrical audio conductor.

10. The cable set according to claim 8,
wherein the at least one electrical audio conductor or the at least one second electrical audio conductor or the at least one signal conductor are arranged in sections directly adjacent to each other or twisted together or enveloped by a common outer shell,
wherein the at least one electrical audio conductor and the at least one signal conductor are divided at a branch off in two strands respectively in a direction towards a first head phone or ear phone and a second head phone or ear phone so that a distance between the first plug or the third plug and the branch off is respectively 40 cm at the most.

11. The cable set according to claim 10, wherein the at least one sensor or at least one additional sensor is arranged in the branch off.

12. The cable set according to claim 1, wherein the at least one sensor is a rate of turn sensor or a motion sensor or a magnetometer or an inertial sensor or a yaw sensor.

13. The cable set according to claim 11, wherein the at least one additional sensor is a rate of turn sensor or a motion sensor or a magnetometer or an inertial sensor or a yaw sensor or a temperature sensor or an air pressure sensor or a humidity sensor or a microphone.

14. The cable set according to claim 10, wherein the receiver unit or the transmitter unit is arranged at the branch off.

15. The cable set according to claim 1, wherein the receiver unit and a transmitter unit are arranged in a pocket transmitter.

16. A method for transmitting an audio signal from a monitoring unit to a head phone or an ear phone arranged at a head of a bearer, the method comprising the steps:
transmitting the audio signal from the monitoring unit to a receiver unit arranged at a body of the bearer;
conducting the audio signal from the receiver unit through a cable set that includes at least one electrical audio conductor that includes a first end that is provided with a first plug that is connectable with an ear phone or head phone wherein the cable set includes a second end that is arranged opposite to the first end and wherein the audio signal is conducted to the head phone or ear phone,
wherein at least one sensor measures an orientation of the at least one sensor relative to ambient,
wherein the at least one sensor is arranged at a distance of 40 cm at the most from the first end of the at least one electrical audio conductor and attached to the first end of the at least one electrical audio conductor,
wherein the orientation of the at least one sensor is forwarded through a signal conductor to a transmitter unit arranged at the body of the bearer and subsequently transmitted to the monitoring unit, and
wherein the monitoring unit puts out the audio signal as a function of the orientation of the at least one sensor.
